(19) United States
(12) Patent Application Publication
(10) Pub. No.: US 2010/0290058 A1
(43) Pub. Date: Nov. 18, 2010

(54) METHOD FOR DETERMINING A PERTURBATION OF AN OPTICAL WAVE

(75) Inventors: Vincent Beau, Gradignan (FR); Frederic Seguineau, Bordeaux (FR)

Correspondence Address: Nixon Peabody LLP, P.O. Box 60610, Palo Alto, CA, 94306, US

(73) Assignee: COMMISSARIAT A L'ENERGIE ATOMIQUE, Paris (FR)

(21) Appl. No.: 12/596,422

(22) PCT Filed: Apr. 18, 2008
(86) PCT No.: PCT/EP08/54725

§ 371 Date: Apr. 1, 2010

(30) Foreign Application Priority Data
Apr. 20, 2007 (FR) 0754604

(51) Int. Cl. G01B 9/02

(52) U.S. Cl. 356/477

(57) ABSTRACT

Method for determining a perturbation of an optical wave, wherein a first wave which has been subject to a perturbation, is caused to interfere with a second adaptive and continuously adjustable wave, used as a reference wave, in order to obtain a set of interference fringes, the phase of the first wave is reconstructed from this set, and the perturbation is determined from the thereby reconstructed phase. The shape of the wavefront of the second wave is dynamically adjusted so as to obtain a number of interference fringes adapted to the reconstruction of the phase.

### CROSS REFERENCE TO RELATED APPLICATIONS OR PRIORITY CLAIM

This application is a national phase of International Application No. PCT/EP2008/054725, entitled “METHOD OF DETERMINING AN OPTICAL WAVE DISTURBANCE”, which was filed on Apr. 18, 2008, and which claims priority of French Patent Application No. 07 54604, filed Apr. 20, 2007.

### DESCRIPTION

1. Technical Field

The present invention relates to a method for determining a perturbation of an optical wave. It belongs to the field of optical metrology by interferometry.

It notably applies to the characterization of defects which are present on optical components and due to damages caused by laser beams.

2. State of the Prior Art

The measurement method by interferometry consists of having a reference optical wave interfere with an optical wave having crossed an optical component, the testing of which is desired (or having been reflected on the latter). Interference of both waves generate a succession of interference fringes from which it is possible to reconstruct the phase of the wave having crossed a defect of the optical component and to infer therefrom the defect which one wants to measure.

In most cases, the reference optical wave is a plane wave. However, with such a wave, for an optical component having significant defects, the size of which is larger than the wavelength λ of the waves which are caused to interfere, the number of fringes becomes too large and measurement is impossible.

In fact, there are many optical metrology techniques intended to measure the defects of optics. The most current are, as this has been seen, based on interference with a reference plane wave; they use interferometers of the Fabry-Pérot, Fizeau or Michelson type.

Mention may also be made of the technique using a Shack-Hartmann analyzer as well as of multi-lateral shift interferometry which is an alternative of the previous one. These techniques are limited to the measurement of local defects, the size of which is smaller than λ.

There also exists a measurement technique called “MIROMA”. On this subject, reference will be made to the following documents:

[1] U.S. Pat. No. 6,339,469, an invention of Jérôme Belledent and Laurent Bruel,

[2] <<Numerical Phase retrieval from beam intensity measurements in three planes>>, Laurent Bruel, Proc. of SPIE., Vol. 4932, May 2003, pp. 590-598.

With this known technique, it is possible to measure defects of the order of several λ. It is based on the measurement of the intensity in three planes. By a calculation (Fresnel integral) of propagation between each measurement plane, and by successive iterations, the phase of the optical wave is obtained. However, with this technique, it is not possible to appreciate the phase of an optical wave originating from a defect, the size of which is larger than 3λ: for such a size, the algorithm used does not converge.

The technique of point diffraction interferometry is also known. On this subject, reference will be made to the following documents:

[3] U.S. Pat. No. 5,933,236, [4] “Extreme Adaptive Optics Testbed: Results and Future Work”, J. W. Evans et al., SPIE Optics and Photonics 2005.

According to this known technique, spherical waves are generated by diffraction, both for the reference wave and for the wave which interacts with the optics to be tested. The spherical waves generated by diffraction are considered as quasi-perfect and, after interference, allow accuracies of the order of λ/1,000 to be achieved.

This measurement technique is based on the comparison of a wave theoretically having no perturbation, with a sister-wave bearing the defects from the tested optics. With it, it is not possible to appreciate defects of large amplitude because the reference wave and the wave passing through the tested optics are initially with the same shape.

Another technique is known by the following document:

[5] “Using Computer Generated Holograms to Test Aspheric Wavefronts”, J. C. Wyant et al., Applied Optics, Vol. 11, No. 12, p. 2833, December 1972.

It consists of engraving a hologram sending back a wave which is close to the wavefront to be analyzed. It is comparable in its principle to the one which uses the Twyman-Green interferometer, but is less expensive than the latter. However, these techniques impose prior knowledge of the general shape of the wave to be analyzed.

The measurement methods mentioned above have drawbacks. Indeed, they are limited as regards the dynamic range of the measurement. Further, they do not presently allow qualification of the optics, the defects of which are totally unknown and the depth of which may exceed a few wavelengths.

Further, in the case of the characterization of optics such as convergent or divergent lenses, the systems used are of the adapted Michelson interferometer or Twyman-Green interferometer kind

In such a configuration, one of the reflection mirrors is a mirror which is adapted to the wavefront delivered by the optics, the characterization of which is desired. It is therefore necessary to have mirrors which are compatible with each optics to be characterized, which entails a high cost for the conducted measurements.

### DISCUSSION OF THE INVENTION

The object of the present invention is to find a remedy to the previous drawbacks.

The object of the invention is a measurement method with which the shape of the wavefront of the reference wave, may be dynamically—i.e. continuously—adjusted in order to have a sufficient number of fringes in order to infer therefrom the phase variation and therefore the shape of the measured defect.

With this method, it is then possible to carry out measurements for defects, the depth of which has a value of several tens of wavelengths, but the method remains compatible with the measurement of low depth defects and with the characterization of conventional optical components.

It should be noted that a particularly complicated wavefront having very strong local variations, may also be measured piecewise with the present invention, by successively carrying out several measurements with different shapes of reference waves; this wavefront may then be reconstructed by means of a suitable software package.

In the present invention, the adaptive reference wave may be a spherical wave which is easy to generate. The radius of curvature of this wave is then modified by causing it to vary continuously, in order to pass from a divergent spherical wave to a convergent spherical wave.

Specifically, the object of the present invention is a method for determining a perturbation of a optical wave, wherein

a first optical wave which has undergone a perturbation is caused to interfere with a second optical wave used as a reference wave, in order to obtain a set of interference fringes,

the phase of the first optical wave is reconstructed from the set of interference fringes, and

the perturbation is determined from the thereby reconstructed phase,

this method being characterized in that the second optical wave used as a reference wave is adaptive and continuously adjustable and in that the shape of the wavefront of the second optical wave is adjusted dynamically so as to obtain a number of interference fringes adapted to the reconstruction of the phase of the first optical wave.

According to a particular embodiment of the invention, the perturbation is determined with the help of several partial determinations, carried out by means of different shapes of the wavefront of the second optical wave.

The second optical wave may be spherical.

According to a particular embodiment of the invention, an optical fiber is used for generating the second optical wave.

An optical system with a variable focal length may be used for dynamically adjusting the shape of the wavefront of the second optical wave.

Preferably, the respective intensities of the first and second optical waves are adjusted in order to maximize the contrast of the interference fringes.

It is possible to use the phase shifting technique in order to remove the uncertainty on the sign of the phase difference between the first and second waves which is measured.

Further, it is possible to associate the measurement method, object of the invention, with the measurement method <<MIROMA>> (an iterative method for reconstructing a wave by multiple acquisitions), in order to increase the measurement dynamic range in the case of extremely strong diffraction.

### SHORT DESCRIPTION OF THE DRAWINGS

The present invention will be better understood upon reading the description of exemplary embodiments, given hereafter purely as an indication and by no means as a limitation, with reference to the appended drawings wherein:

FIG. 1 is a schematic view of a device for applying a method according to the present invention, and

FIG. 2 schematically illustrates a spherical wave used as a reference wave in an example of the invention.

### DETAILED DISCUSSION OF PARTICULAR EMBODIMENTS

An optical measurement device for applying the invention allows dynamic modification of the wavefront of a reference wave in order to adjust it to wavefronts for which characterization is desired, notably the fronts of the waves which stem from optics of any type (convergent or divergent optics) or from defects.

The characterization of an optical object may also be achieved in several measurements if the wavefront is locally very strongly perturbed. Subsequently, by continuity at the overlapping areas of the measurements, it is possible to reconstruct the totality of the wavefront of the wave stemming from the optical object to be characterized.

One of the embodiments of the tunable reference wavefront measurement method, object of the invention, uses as a tunable reference wave, a spherical wave, the curvature of which is varied.

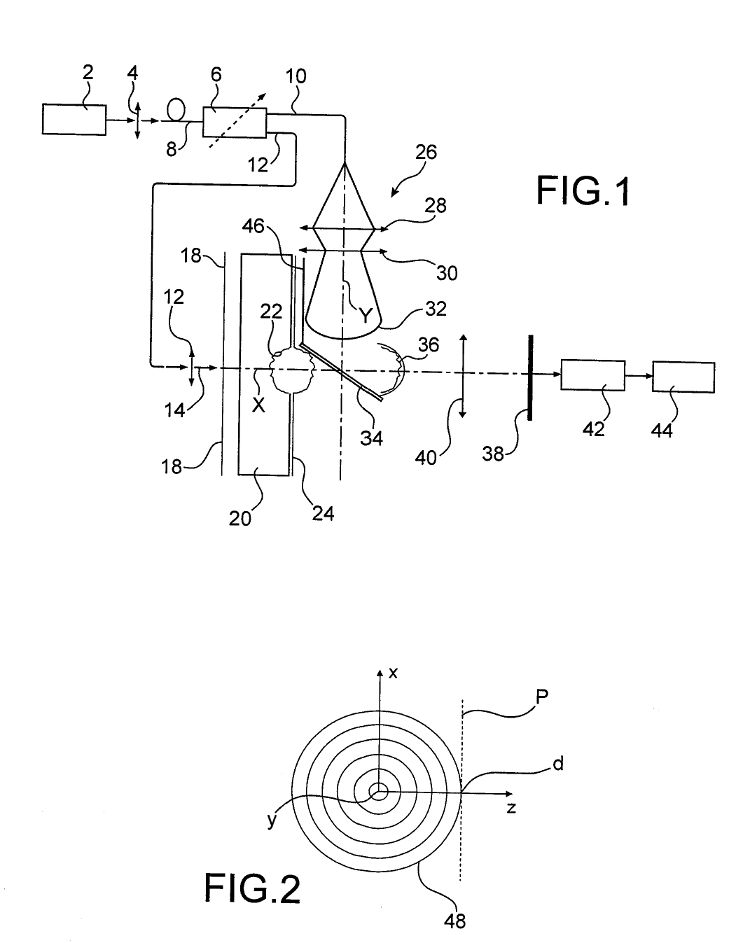

FIG. 1 is a schematic view of a device for applying this tunable reference wavefront measurement method, in the case of a spherical reference wave.

This device comprises:

a laser 2 which emits light with wavelength λ,

a convergent lens 4, and

an optical coupler 6 with one input 8 and two outputs 10, 12.

The light of the laser is sent into the input 8 via the lens 4.

The light from the output 10 is transformed into a plane light wave 14 via a convergent lens 16. This wave propagates along an axis X. A wave plane (perpendicular to this direction) has reference 18.

An optical component to be tested 20 having a defect 22 receives the plane wave 14 and provides at the output a plane wave 24 which is perturbed by the defect 22.

The device also comprises an optical system with a variable focal length 26, formed with several lenses 28, 30.

This system provides the spherical reference wave 32 which is divergent in the illustrated example. This wave propagates along the axis Y of the system 26. This axis Y is perpendicular to the axis X and encounters the latter.

The device further comprises a splitter plate 34 which is placed at the point of intersection of the axes X and Y, at 45° from the latter. This splitter plate allows the perturbed wave 24 to interfere with the reference wave 32. The light resulting from the interference of both waves has reference 36 in the figure.

The device also comprises an optical detector 38 of the CCD type which receives this light 36 via an optical measurement system 40. Electronic means 42 are further provided for processing the signals provided by the detector 38 in order to characterize the defect 22 of the optical component 20. The electronic means 42 are provided with means 44 for displaying the results.

The optical component to be characterized 20 may have a very large surface defect, for example resulting from a laser impact.

The measurement principle consists of having the plane wave perturbed by the defect of the optical component interfere with the spherical reference wave, the curvature of which is close to that which is produced by the defect. By knowing the spherical reference wave, interference fringes (neither too many, nor too few) may be observed, allowing reconstruction of the wavefront induced by the defect.

It is specified that a mask 46 is provided in the device of FIG. 1 in order to prevent the reference wave from attaining the component 20.

The spherical reference wave with variable curvature (in the case illustrated in FIG. 1) is, as this was seen, generated by the optical system with variable focal length 26. It is then possible to dynamically modify the curvature of the spherical wave at will, from a strongly divergent wave right up to a strongly convergent wave.

In the case when a divergent spherical reference wave is sufficient, the latter may be generated by a simple optical fiber, which limits the bulkiness of the device. Further, the spherical wave generated by such an optical fiber is quasi perfect since it is free of any aberration.

In this case, the shape of the wavefront of the reference wave is adjusted by displacing, along the axis Y, the end of this fiber from which emerges the reference wave.

In the case when the spherical wave is generated by a system with variable focal length, consisting of several lenses, the latter should be characterized beforehand (measurement of the aberrations of the variable focal length system).

Preferably, in order to maximize the contrast in the interference fringes, a variable coupler is used as a coupler 6, allowing adjustment of the respective intensities of the reference wave 32 and of the wave 14 illuminating the object to be characterized, by distributing the light power among these waves 14 and 32.

In order to achieve the measurement, the phase shift of the spherical wave needs to be known with accuracy. This phase shift is given by the following expression:

$${e}^{- i \frac{2 π}{λ} \cdot \frac{{x}^{2} + {y}^{2}}{2 d}} \qquad ( 1 )$$

FIG. 2 schematically illustrates a spherical wave 48. The expression (1) corresponds to a phase shift calculated in a measurement plane P, the abscissa z of which is equal to a value d. It is specified that a reference system is used having an origin O and three axes x, y, z perpendicular to each other. The axis y is perpendicular to the plane of FIG. 2.

The spherical wave is entirely known by this parameter d which represents the distance from the source point (origin O of the reference system) to the measurement plane P, this source point being the point from which the spherical wave leaves.

The following calculation gives the required accuracy for d, in the case of the measurement of a defect with a depth of 21 μm, with a total width (diameter) of 1 mm, with a measurement accuracy of 0.1 π (refractive index of the tested optical component: 1.5).

The phase of the spherical wave has the value:

$$Φ = - \frac{2 π}{λ} \cdot \frac{{x}^{2}}{2 d} \qquad ( 2 )$$

The variation of the phase as a function of the variation of d therefore has the value:

$$ΔΦ = \frac{2 π}{λ} \cdot \frac{{x}^{2}}{2 {d}^{2}} \cdot Δ d \qquad ( 3 )$$

With the preceding parameters: Δd not very different from 20 μm is obtained. The accuracy on d is quite acceptable. The distance d may be directly measured with the measurement optics 40 (FIG. 1).

This measurement optics 40 is preferably mounted on a micrometric displacement stage, which allows d to be measured with an accuracy of the order of l μm.

The interference of the wave passing through the defect with the spherical reference wave gives an interference pattern which is described by equation (4) giving the intensity of this interference pattern:

$$I = 1 - cos [ Φ - \frac{2 π}{λ} \cdot \frac{{x}^{2}}{2 d} + \frac{2 π}{λ} d + {ϕ}_{1} ] \qquad ( 4 )$$

where φ₁ is the phase due to the propagation of the plane wave passing through the defect and

$$\frac{2 π}{λ} d$$

is the phase due to the propagation of the spherical reference wave.

In order to remove the uncertainty on the sign of the phase difference which is measured, it is possible to use the phase shifting technique. On this subject, reference will be made to the following document:

[6] “Phase shifting interferometry: reference phase error reduction”, J. Schwider, Applied Optics, Vol. 28, No. 18, 1989, pp. 3889-3892.

This technique consists of varying parameter d by ±λ/4, and of observing the displacement direction of the interference fringes. The variation of d may be achieved by means of a piezoelectric component.

It is possible to combine the tunable reference wavefront measurement method, according to the invention, with the MIROMA measurement method. Indeed, in certain particular cases, for example in the case of very strong diffraction, the phase measurement may be conducted upon moving away from the optical object to be characterized. Next, by applying the MIROMA method, the phase may be calculated in the desired plane. With this, it is possible to increase the dynamic range of the device for applying the method.

It is specified that the reference wave used in the examples is spherical, but the invention may also be applied with other shapes of reference waves.

The measurement method, object of the invention, has advantages. It has high dynamic phase measurement and with it, it is possible to measure extremely large optical phase variations with a relatively simple device.

This measurement method may be adapted to any shape of wavefront relating to a wave which is generated by a convention optical component (for example a lens or a phase plate) or which stems from a defect resulting from a laser impact on an optics, in which case the shape of the wavefront is very complicated and totally unknown.

To this day, the technique, object of the invention, is the only one which allows processing of defects with a very large depth (several tens of micrometers, over a few hundred micrometers in width). Further, the measurement accuracy is similar to what is obtained with conventional interferometric methods, i.e. of the order of λ/50.

The originality of this technique lies in the possibility of tuning at will the shape of the reference wave surface relatively to the wave to be characterized in order to optimize the number of interference fringes.

Further, this optical characterization technique gives the possibility of measuring phase variations originating from very large defects (several tens of micrometers, over a few hundred micrometers in width), which was totally impossible up to now.

This invention has many applications. Its main goal is to characterize defects present on optics and due to laser damages. However, the invention may be used for characterizing any type of deformation of the wavefront with a measurement accuracy of λ/50. This technique may also be used for characterizing strongly perturbed light pulses, for example after passing through non-linear optical elements. It may also be used for measuring the wavefront in a gas or aqueous medium which is strongly perturbed and which therefore strongly perturbs an optical wave which passes through it.

Within the scope of a more conventional application, the method of the invention may be used for characterizing conventional optics, for example convergent or divergent lenses. For this application, it is no longer necessary to make a reference mirror adapted to the wavefront which is generated by each of the optics to be characterized.

1. A method for determining a perturbation of an optical wave, wherein
a first optical wave which has been subject to a perturbation is caused to interfere with a second optical wave used as a reference wave, in order to obtain a set of interference fringes,
the phase of the first optical wave is reconstructed from the set of interference fringes, and
the perturbation is determined from the thereby reconstructed phase,
this method being characterized in that the second optical wave used as a reference wave, is adaptive and continuously adjustable and in that the shape of the wavefront of the second optical wave is continuously adjusted so as to obtain a number of interference fringes adapted to the reconstruction of the first optical wave.

2. The method according to claim 1, wherein the perturbation is determined by means of several partial determinations, carried out by means of different shapes of the wavefront of the second optical wave .

3. The method according to claim 1, wherein the second optical wave is spherical.

4. The method according to claim 1, wherein an optical fiber is used for generating the second optical wave.

5. The method according to claim 4, wherein the shape of the wavefront of the second optical wave is continuously adjusted by displacing the end of the optical fiber from which emerges the second optical wave.

6. The method according to claim 1, wherein an optical system with variable focal length is used for continuously adjusting the shape of the wavefront of the second optical wave.

7. The method according to claim 1, wherein the respective intensities of the first and second optical waves are adjusted in order to maximize the contrast of the interference fringes.

8. The method according to claim 1, wherein the phase difference between the first and second waves is measured and the phase shifting technique is used for removing the uncertainty on the sign of this phase difference.

9. The method according to claim 1, wherein this method is associated with the iterative method for reconstructing a wave by multiple acquisitions, in order to increase the measurement dynamic range in the case of extremely strong diffraction.
